(19) United States
(12) Patent Application Publication
(10) Pub. No.: US 2004/0174718 A1
(43) Pub. Date: Sep. 9, 2004

(54) Illuminated balloon, protable balloon kit, advertising method & method of enhancing festive occasions

(76) Inventor: Stephen K Ohlund, San Luis Obispo, CA (US)

Correspondence Address: Connors & Associates, 1600 Dove Street #220, Newport Beach, CA, 92660-2427, US

(21) Appl. No.: 10/491,017

(22) PCT Filed: Sep. 25, 2002
(86) PCT No.: PCT/US02/30536

Related U.S. Application Data
(60) Provisional application No. 60/325,359, filed on Sep. 27, 2001.

(51) Int. Cl. F21S 4/00

(52) U.S. Cl. 362/565

(57) ABSTRACT

A lighter-than-air balloon (17) is illuminated from within by an internal light source (18). This light source (18) may be energized by a power source carried on-board the balloon when aloft, or from a ground based power source (32) tethered to the balloon (17) by a conductor (30) connected to the light source (18). Spectators attending an event, usually a festive occasion, may use a switch 36) on ground to switch on and off the light source (18) aloft in the balloon (17). By displaying on an internally illuminated balloon (17) while aloft indicia (17b) of the subject being advertised, a very creative and effective advertisement is broadcaster over a wide geographically area potentially reaching millions of onlookers.

### RELATED PATENT APPLICATIONS & INCORPORATION BY REFERENCE

This application is a PCT application based on U.S. provisional patent application Serial No. 60/325,359, entitled “ILLUMINATED BALLOON, PORTABLE BALLOON KIT, ADVERTISING METHOD & METHOD OF ENHANCING FESTIVE OCCASIONS,” filed Sep. 27, 2001. This related provisional is application incorporated herein by reference and made a part of this application. If any conflict arises between the disclosure of the invention in this PCT application and that in the related provisional application, the disclosure in this PCT application shall govern. Moreover, Applicant incorporates herein by reference any and all U.S. patents, U.S. patent applications, and other documents cited or referred to in this application or cited or referred to in the U.S. patents and U.S. patent applications incorporated herein by reference.

### BACKGROUND OF THE INVENTION

Balloons are frequently used at parties or other events to create a festive atmosphere or promote and advertise. Cartoon characters are frequently printed on the surface of the balloons. Advertisements have also been imprinted, or otherwise, affixed to balloons. Balloons so marked with advertisements are distributed as gifts to prospective buyers to create buyer awareness for the advertiser's products or services.

### SUMMARY OF THE INVENTION

This invention, with its several desirable features, is defined in the CLAIMS that follow. After reading the following section entitled “DETAILED DESCRIPTION,” one skilled in the art will understand the benefits this invention provides. These benefits include, but are not limited to: (1) creating a festive atmosphere at parties, conventions, outdoor and indoor concerts, political rallies, and other events, (2) the novelty of an illuminated balloon bearing a favorite cartoon or other character or scene, (3) convenience of use and distribution, (4) low cost, and (5) providing a new advertising medium.

Some, but not all, of the features of this invention are:

With this invention, the characteristics of a lighter-than-air balloon, and its uses, are enhanced by illuminating the balloon from within. Indicia of a subject to be advertised may be displayed on such an internally illuminated balloon while aloft. This use of the internally illuminated balloon is to a novel and effective way to create advertisements with high viewer impact that are broadcasted over a wide geographically area, potentially reaching millions of onlookers. These onlookers may be prospective customers, voters, fans at sporting contests, military personnel, potential converts, or any other audience.

The balloon of this invention includes an internal light source. This light source may be energized by a power source carried on-board the balloon when aloft, or from a ground based power source tethered to the balloon by a conductor connected to the light source. A switch may be used by persons, herein spectator(s), attending an event, usually a festive occasion, to switch the tethered light source on and off.

According to the advertising method of this invention, indicia of a subject is displayed on a balloon illuminated from inside when the balloon is aloft. The balloon may or may not be tethered. A benefit of the tethered balloon is that the useful life of the power source, typically one or more batteries, is extended because the light source may be turned off when desired. The untethered balloon that carries with it aloft the on-board power source, once this power source is turned on it remains on until exhausted.

A section of the balloon is transparent or translucent to enable light to illuminate the indicia of the subject and draw spectator attention to the illuminated balloon. At a gathering of spectators at an event promoted on behalf of, or by, the subject, at least one of the spectators sends an illuminated balloon aloft by inflating and releasing it. Preferably, many of the spectators release illuminated balloons advertising the subject. When the spectators do this simultaneously, the greatest advertising impact is achieved. The balloons may be tethered by a lightweight, two-way conductive wire to a ground based, portable control unit including the power source under the control of the on-off switch. Alternatively, a balloon-inflating device mounted on-board the balloon provides a light source and a power source therefor that is carried aloft with the balloon after inflation with the lighter-than-air gas. Typically, the balloon-inflating device is a rigid member that is inserted into an open mouth of the balloon that has a passageway therein to allow the lighter-than-air gas to flow into and inflate the balloon.

### DESCRIPTION OF THE DRAWING

The preferred embodiments of this invention, illustrating all its features, will now be discussed in detail. These embodiments depict the novel and non-obvious balloon, balloon-inflating device, balloon kit, and method of advertising of this invention as shown in the accompanying drawing, which is for illustrative purposes only. This drawing includes the following figures (Figs.), with like numerals indicating like parts:

FIG. 1 is a side elevational, schematic view of the first embodiment of this invention depicting a balloon-inflating device that is used to inflate and illuminate a balloon attached to this device.

FIG. 2 is a side elevational, schematic view of the balloon-inflating device shown in FIG. 1 attached to a balloon, with sections of the balloon broken away.

FIG. 3 is a perspective view of the balloon-inflating device shown in FIG. 1 using a transparent body member.

FIG. 4 is a schematic view of the second embodiment of this invention showing the unassembled components of a tethered, internally illuminated balloon device.

FIG. 4A is a side view, with sections broken away, of a tube with a light source at an end that is adapted to be inserted into the neck of a balloon.

FIG. 5 is a schematic view showing the assembled components of the tethered, illuminated balloon illustrated in FIG. 4, with sections of the balloon broken away.

FIG. 6 is a schematic view depicting a kit including components for assembling a number of tethered, illuminated balloons.

FIG. 7 is a perspective view of a hand-held, ground based, portable control unit displaying a cartoon character.

FIG. 8 is a perspective view of a balloon illuminated in accordance with this invention.

FIG. 9 is a schematic view depicting a tethered, illuminated balloon device of this invention, with sections of the balloon broken away, showing one embodiment of a closure member in an open position to allow the gas to enter a normally open end of the balloon to inflate the balloon.

FIG. 9A is a fragmentary view, with sections broken away, of the closure member used with balloon device shown in FIG. 9.

FIG. 10 is a schematic view similar to that of FIG. 9, depicting the closure member in a closed position.

FIG. 11 is a schematic view depicting a tethered, illuminated balloon device of this invention, with sections of the balloon broken away, showing an alternate embodiment of a closure member in an open position to allow the gas to enter a normally open end of the balloon to inflate the balloon.

FIG. 12 is a schematic view similar to that of FIG. 11, depicting the closure member in a closed position.

FIG. 13 is a side view, with sections broken away, of a partially deflated Mylar balloon showing an internal-self sealing gas conduit within the balloon in an open condition allowing gas to flow into the balloon.

FIG. 14 a side view, with sections broken away, of the Mylar balloon shown in FIG. 13 showing the internal-self sealing gas conduit within the balloon in a closed condition preventing gas from escaping from the balloon.

FIG. 15 is a perspective view, with sections broken away, of another embodiment of this invention using a Mylar balloon having an internal reflective surface.

### DETAILED DESCRIPTION

### Some Preferred Embodiments

### A First Embodiment

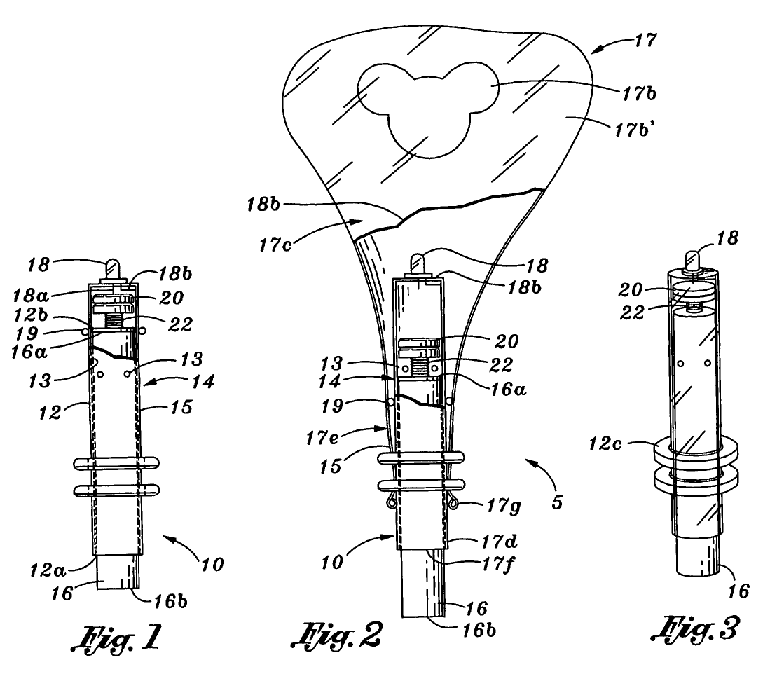

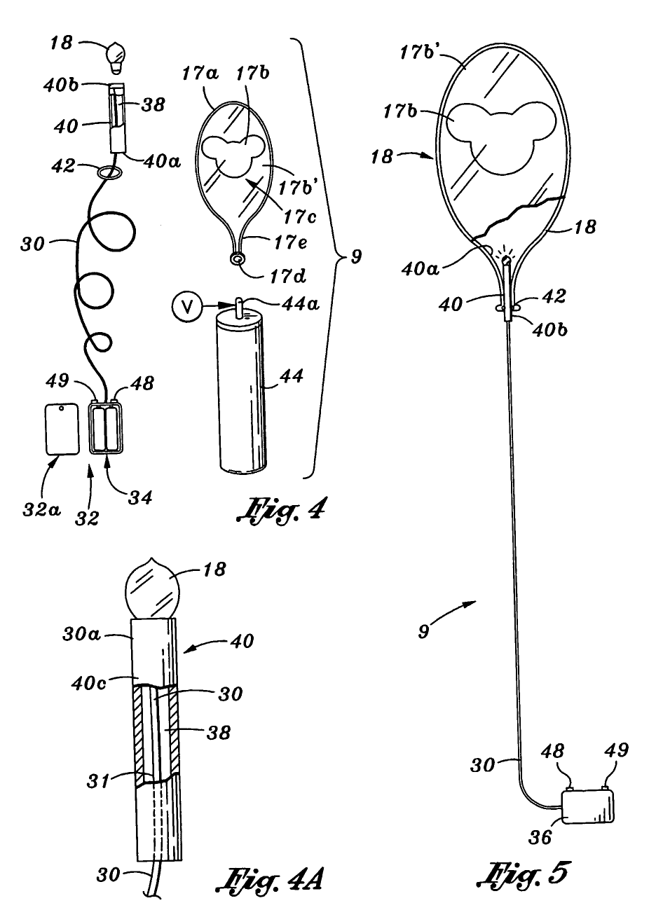

A first embodiment of the invention shown in FIG. 2 is an internally illuminated balloon device 5 that is not tethered to the ground. It employs a balloon-inflating device 10 shown in FIG. 1. This balloon-inflating device 10 includes a rigid, tubular body member 12 having an inlet 12a and outlet 12b and orifices 13 between the inlet and outlet. The body member 12 may be made of a light weight, opaque material such as aluminum or a light weight, transparent plastic material such as illustrated by the body member 12c shown in FIG. 3. Preferably, the tubular body member 12 has a wall 15 of circular-cross section. There is a passageway 14 between the inlet 12a and outlet 12b to enable a lighter-than-air gas, such as, for example helium, to flow through the passageway 14. A small canister holding the gas that is release quickly by a fast action release mechanism such as a pull string may be attached to the tubular body member 12. As soon as the gas is released, the canister is detached from the tubular body member 12. The gas flows into the inlet 12a and through the outlet 12b, when a closure member such as, for example, a plug 16 has been manually moved between a closed position shown in FIG. 1, terminating any gas flow, to an open position shown in FIG. 2. The plug 16 has a circular-cross section, or tapered-cross section, when the body member 12 has a circular-cross section. Thus, the plug 16 fits snugly against the tubular wall 15 when pushed forward towards the outlet 12b. With the plug 16 in the pushed forward position shown in FIG. 1, it closes off the orifices 13, preventing gas from flowing through the inlet 12a, either into or from this inlet. The plug 16 thus acts as a valve that enables the gas to flow into or from a balloon 17 attached to the body member 12 at the outlet 12b.

The balloon 17 comprises a lightweight inflatable member 17a made of an elastic, resilient material such as, for example, rubber or latex. Or, it may be made of an inelastic plastic material such as, for example, Mylar, that does not expand easily, but acts as a barrier to hold the gas within the balloon for an extended period of time. The balloon 17 has a transparent or translucent section 17b within an opaque background 17b′ and a cavity 17c having a neck 17e terminating in a single open end 17d through which the gas enters to fill the cavity and inflate the member 17a.

When the balloon 17 is attached to the body member 12 and the plug 16 is in the closed position, any lighter-than-air gas introduced into the balloon 17 does not escape from the cavity 17c. As shown in FIG. 2, the tubular body member 12 extends into the neck 17e and pair of external O-rings 24 pulled snug over the external surface of the neck 17e hold the balloon 17 firmly to the body member 12. The O-rings 24 are between the orifices 13 and the inlet 12a from which a portion of the plug 16 extends. These O-rings 24 serve as a balloon clamp adapted to hold the balloon 17 at the outlet 12a to enable it to be inflated with gas that flows into the inlet 12a though said passageway 14 and out the outlet 12b. When the balloon is made of an elastic material, there is an elastic, rubber band type element 17g at the mouth 17f (FIG. 2) of the balloon at the end of the single open end 17d of the balloon. The rubber band type element 17g serves as a balloon clamp, thereby eliminating the need for the O-rings 24.

As depicted in FIGS. 1 and 2, the body member 12 holds a light weight light source such as, for example, a light bulb or light emitting diode (LED) 18 having a negative terminal 18a and a positive terminal 18b and a light weight power source such as, for example, alkaline batteries 20 (GP 27A 12 volt sold by Radio Shack). The batteries 20 are connected by a spring 22 to a distal end 16a of the plug 16. An internal O-ring 19 surrounds this distal end 16a and moves laterally with the plug 16 as the plug is manually moved between the open and closed positions. The plug 16 thus serves as a control switch connected in a circuit including the LED 18 and the batteries 20. Upon inflating the balloon 17, a spectator at an event pushes the plug 16 forward causing the passageway 14 to be closed off. At the same time as the plug 16 is pushed forward, it makes contact with the negative lead 18a of the LED 18 to complete a circuit to provide energy to the LED. This allows the balloon 17, while suspended in the atmosphere, to be illuminated from inside of cavity 17c. The balloon inflating device 10 is lighter than the inflated balloon 17.

### A Second Embodiment

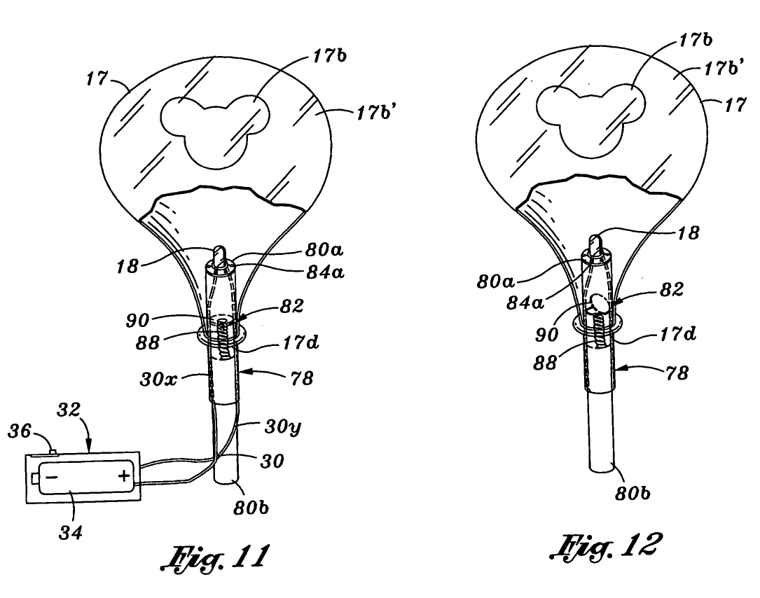

A second embodiment of the invention shown in FIGS. 4, 4A and 5 is an internally illuminated balloon device 9 that is tethered to the ground. As shown in FIGS. 4, 4A and 5, the balloon 17 is tethered with a lightweight, two-way conductive wire 30 to a ground-based, portable control unit 32. The weight of the wire 30 does not exceed the weight of the inflated balloon 17. The wire 30 has two conductive strands 30x and 30y (FIG. 11) to allow current to travel from the control unit 32 to the LED 18 inside the balloon 17.

There are batteries 34 housed within the control unit 32, which has a removable cover 32a to provide access to the batteries when they need to be replaced. The two-way conductive wire 30 has one end 30a connected to the LED 18 and another end 30b connected to the batteries 34. As best shown in FIG. 4A, the LED 18 is mounted to the one end 30a of a tube 40. The wall 40c of the tube 40 is broken away to show that a tunnel 38 is provided through which the wire 30 extends. A sealing substance 31 fills this tunnel 38 to avoid gas escaping from the tunnel. The tube 40 is inserted into the neck 17e of the balloon 17 to put the LED 18 within the cavity 17c of the balloon. The control unit 32 includes an on-off switch 36 that controls connection of the LED 18 to the batteries 34. This switch may be a mechanical or push button electronic switch.

The single open end 17d of the balloon 17 provides an inlet for the gas. This open end 17d is connected to an outlet 44a of a canister 44 containing helium and the helium flows from the canister under the control of a manually operable valve V to inflate the balloon. An O-ring 42 stretched around the exterior surface of the wall 40c acts as a closure member or balloon clamp adapted to hold the neck 17e of the balloon 17 firmly against exterior surface of the inserted tube 40. After filling the balloon 17 with the helium gas, the tube 40 is inserted into the neck 17e and the O-ring 42 is pulled over the exterior of the neck 17e. The O-ring 42 clamps the neck 17e tightly against the tube wall 40c, so that the introduced gas does not escape from the balloon 17. The on-off switch 36 is manually actuated to apply power to the LED 18. The control unit 32 may include a music chip 48 and speaker 49 to provide a source of music. The LED 18 may be manually or automatically turned on and off synchronously with the music. Thus, with the balloon 17 aloft it is illuminated from inside, creating a visual effect than can be seen for great distances.

### A Third Embodiment

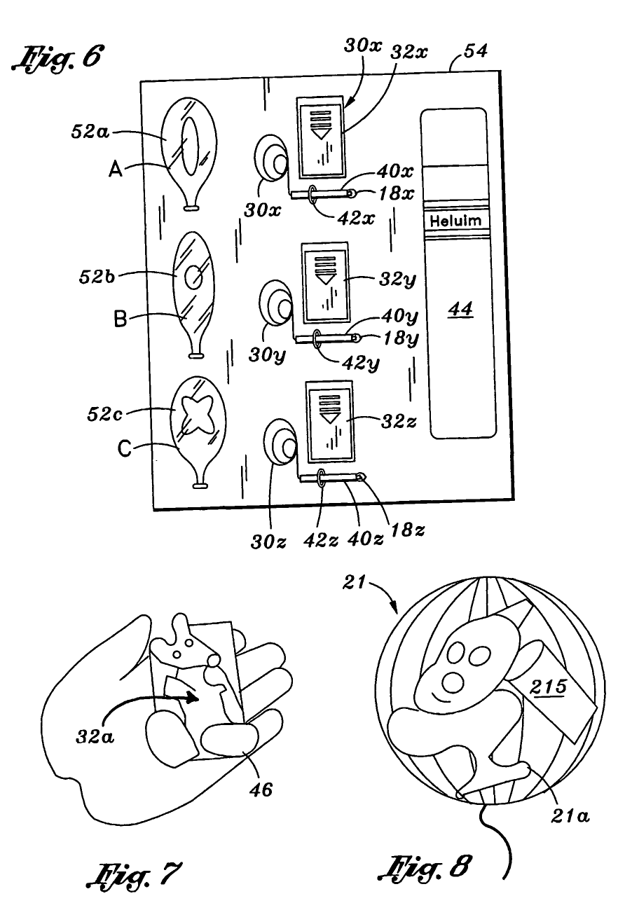

As illustrated in FIG. 6, a third embodiment of this invention is a balloon kit 50 including the following disassemble parts contained within a package 54:

(1) a light weight, not to exceed 5 pounds, portable tank or canister 44 of helium gas used to fill the balloons with gas periodically;

(2) three balloons (or more) 52a, 52b, and 52c, each balloon having a different transparent or translucent section A, B and C;

(3) three (or more) ground based, portable control units 32x, 32y and 32z having a battery compartment to holding a battery and an on-off switch;

(4) three (or more) two-way conductive wires 30x, 30y, and 30z, each being in length of from 5 to 20 feet, with an LED 18x, 18y and 18z attached to tubes 40x, 40y, and 40z by O-rings 42x, 42y, and 42z.

These components are adapted to be assembled in the same manner as discussed in connection with the balloon 17 shown in FIGS. 4 and 5 so that each balloon 52a, 52b, and 52c is illuminated from within each balloon. The advantages of the kit are its low cost, portability, and ease of distribution to a group of spectators at an event. There may be special events where large helium storage tanks having a weight in excess of five pounds is used, for example of large helium storage tanks weighing in excess of about 150 pounds, or greater, may be used advantageously. For example, the advertising method of this invention that is discussed in greater detail subsequently, may in many situations use such large helium storage tanks. A major benefit of this invention is that the internally illuminated balloons may be seen at great distances, especially at night. This increases the economic valve of the advertising method of this invention because an expanded audience is created, especially when large numbers of such balloons are released simultaneously. The different transparent or translucent section A, B and C may each correspond to indicia advertising the same subject, or to different subjects, or simply be a symbol of the like associated with an festive occasion such as, for example, holidays such as New Year, Fourth of July, Thanksgiving or other events such as birthdays, weddings, theme parks or theme park activities, etc.

### A Fourth Embodiment

A fourth embodiment of the invention shown in FIGS. 9, 9A and 10 is an internally illuminated balloon device 60 that is tethered to the ground. It is similar to the second embodiment of this invention in that it has a ground based control unit 32 with the wire 30 connected to the LED 18 lodged within the balloon 17. The control unit 34 has a screw cap 34f that acts as a switch to open or close a circuit for the LED 18 by simply screwing in the cap in one direction or the other.

A manually operated closure member, in some respects like the closure member depicted in FIGS. 1 and 2, is formed by a pair of lightweight tubes, for example, plastic or aluminum tubes 62 and 64. These tubes 62 and 64 are telescopically mounted together and inserted as an assembly into the neck 17e of the balloon 17. The external tube 62 has an orifice 66 in an intermediate position in the tube's wall 62a between an open end 62b and a closed end 62c of this tube. There is a passageway 64d extending between the open ends 64b and 64c of the internal tube 64.

The tube 64 is manually slideable between an open position shown in FIGS. 9 and 9A to unblock the orifice 66 and a closed position shown in FIG. 10 to block the orifice. Gas from the canister 44 is introduced into the end 17d of the balloon 17 through the open end 64b of the tube 64. When unblock, the gas flows along the passageways 62d and 64d, and then through the orifice 66 into the balloon 17. The end 62c has the LED 18 attached to it by a bracket 70 that seals this end 62c. The wire 30 extends through the passageways 62d and passageway 64d. It has one end 30a electrically connected to the LED 18 and the other end 30b (FIG. 9) electrically connected to the batteries 34 in the control unit 32. The abutting walls 62f and 64f, respectively of the tubes 62 and 64, are pushed snug against each other to close off and seal the orifice 66 when the internal tube 64 is moved inward as indicated by the arrow a.

### A Fifth Embodiment

A fifth embodiment of the invention shown in FIGS. 11 and 12 is an internally illuminated balloon device 78 that is tethered to the ground. It employs a closure member that opens automatically in response to the pressure of the gas being expelled from the canister 44. This closure member comprises a tube 80 having a valve 82 positioned inside it. This tube 80 has one end 80a inserted through the open end 17d into the neck 17e of the balloon 17 prior to inflating the balloon. Its other end 80b is connected to the canister 44 when the balloon 17 is to be inflated. The two strands 30x and 30y of the wire 30 are inside the tube 80 and pass by the valve 82. These strands 30x and 30y are sealed to prevent gas leakage from the balloon 17 when it is inflated. Electricity from the batteries 34 in the control unit 34 flows along the wire 30 under the control of the manually operated on-off switch 36 to and from the LED 18 along the separate electrical paths provided by the strands 30x and 30y.

The LED 18 is mounted by a spider bracket 84 to the end 80a of the tube 80. The spider bracket 84 provides openings 84a through which gas passes when the valve 82 is opened. The other end 80b is also open to allow gas to flow through the tube 80 under the control of the valve 82. The valve 82 has a hinged door 90 seated in the tube 80 that is biased by a spring 88 to close off the tube and prevent gas from entering the open end 17d of the balloon 17. The spring 88 is weaker than the pressure of the gas in the canister 44. Consequently, when the outlet 44a of a canister 44 is placed in fluid communication with the tube 80 and the valve V is opened, the door opens as shown in FIG. 12, allowing gas to flow into the balloon 17. Discontinuing fluid communication between the canister 44 and the tube 80, exposes the door 90 to atmospheric pressure, which is insufficient to overcome the biasing force of the spring 88, resulting in the door closing to retain the introduced gas within the balloon 17.

### A Sixth Embodiment

As shown in FIG. 15, a sixth embodiment of the invention comprises a balloon 100 having an internal reflective surface 100a that is internally illuminated by a light source 102. This sixth embodiment is similar to the embodiments using a tethered balloon. It has a hand held battery control unit 104 with an on/off switch and a two-way conductor wire 106 used as the tethering string for the balloon. The two conductive wire 106 extends through a tube 108 and connects the light source to the control unit 104, which includes batteries as the power source for the light source 102.

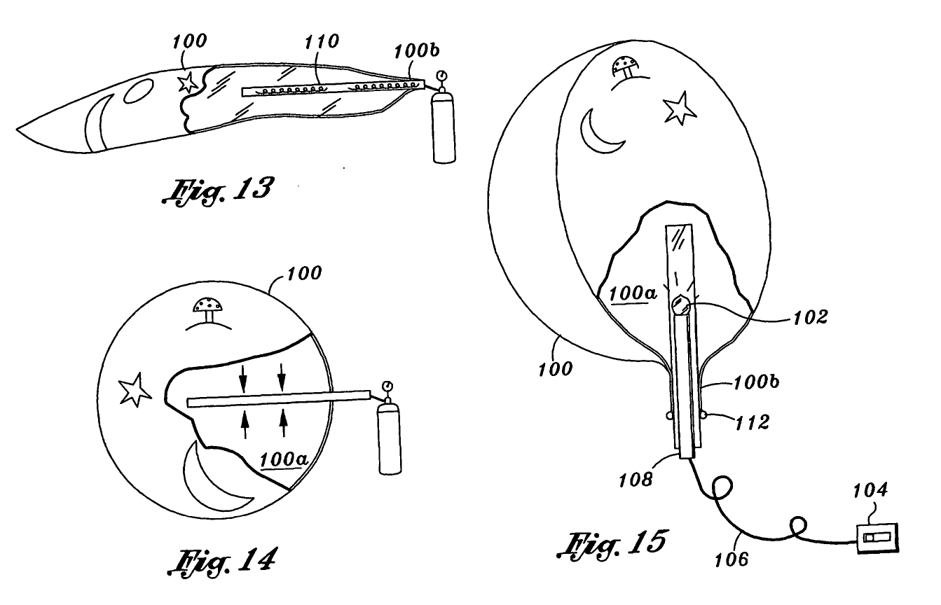

In this sixth embodiment, the balloon 100 is made of Mylar, or equivalent material. Many Mylar balloons have an internal metallized surface 100a that is reflective and an added self-sealing feature built into the balloon. As depicted in FIGS. 13 and 14 extending from the neck 100b of the balloon 100 into the balloon is a conduit 110 that is normally flatten in a closed position. The conduit is translucent or transparent to allow light the pass there through. Gas flows through this conduit 110, opening it to fill the balloon 100. When the pressure produced by the gas within the balloon is sufficiently elevated, the conduit 110 is again flatten and closed as depicted in FIG. 14. This balloon 100 is therefore self-sealing due to the back pressure of the gas inside the balloon. This keeps the lighter than air gas from leaking from the neck 10b. This also makes it so that a Mylar balloon does not need to be tied off at the neck, but as shown in FIG. 15 preferably a n O-ring or rubber band 112 is used for this purpose. Because of the internal reflective surface 100a of the balloon 100, the effect of illuminating the balloon internal is greatly enhanced.

### Advertising Method

Internally illuminated balloon devices of this invention provide a new advertising medium. Indicia of a subject to be advertised is placed on the balloon 17. The indicia may be any name, image, symbol, trademark, company logo, party emblem, or other signs identifying the subject. The indicia may be imprinted, or otherwise formed, on the material of the balloon, for example being in the form of a silhouette or outline of a particular subject being advertised. This indicia is dramatically and visually displayed upon energization of the light source and may be seen at great distances, especially at night. The source of music discussed above in connection with the first embodiment may play music identified with the subject being advertised. Since balloons are low cost and may be reused, the advertising method of this invention is very affordable.

Typically, a trademark is displayed on the balloon. For example, the transparent or translucent section 17b of the balloon 17 is an outline of the cartoon character, advertising, for example, an amusement park. At a gathering of spectators at an event promoted on behalf of, or by, the amusement park, at least one spectator sends the illuminated balloon 17 aloft by inflating and releasing it. In the embodiment depicted in FIG. 7 is sized to be conveniently held in one hand of an adult user. The cover 32a may have an image, symbol, etc. of the subject being advertised displayed on the cover 32a, for example, a figurine 46 of a cartoon character identified with the amusement park being advertised.

This invention enables several spectators at an event to create an appealing array of floating balloons bearing images of cartoon characters, famous people, or company logos, etc. These internally illuminated balloons may be viewed by anyone attending the event, and even from afar by those not attending the event. This invention enhances balloons for all types of people: kids, parents, company parties, advertising, theme parks, movie productions, plays, car dealerships, or anyone else that would be in advertising from a distance. Very large balloons with internal lighting can be seen for miles. The Mylar balloons have a definite added advantage because the internal illumination makes them look three dimensional just by adding light to the inside of the balloon. The light allows the balloon to show its full potential in colored pictures or characters.

### Festive Occasions

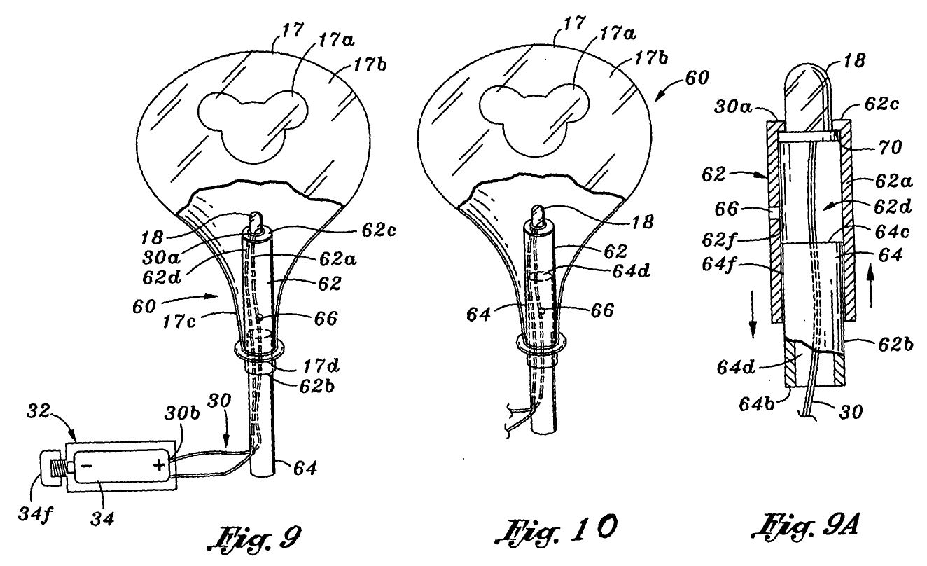

At parties, or other festive occasions, internally illuminated balloons 21 having symbols, or favorite characters or scenes, thereon are inflated and released. For example, as shown in FIG. 8, a balloon 21 has a cartoon character 21a imprinted on the surface 21s of the balloon. The material from which this balloon 21 is made is sufficiently transparent or translucent to enable the light emanating from within the balloon to illuminate this character 21a. The light shines through the material that is not imprinted with any opaque ink forming the outlines of the character. This draws spectator attention to the internally illuminated balloon 21. In this case, the character 21a is invisible until the balloon 21 is illuminated. It is the illumination of the balloon 21 that displays the character 21a and makes it visible.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A balloon, including
a light weight, inflatable member having a transparent or translucent section,
said member having a cavity with an open end through which gas enters to fill the cavity and inflate the member, said open end being closed after being filled with gas,
a light weight light source positioned within the cavity that illuminates the member from inside the cavity, with light from said light source passing through said transparent or translucent section,
a light weight, two-way conductive wire having one end connected to the light source and another end adapted to be connected to a power source.

2. The balloon according to claim 1 including a ground based, portable control unit having a battery and an on-off switch, said two-way conductive wire having said end adapted to be connected to a power source connected to the control unit, enabling said battery to supply power to the light source under the control of the on-off switch.

3. The balloon according to claim 1 where the light source is at or near the open mouth.

4. The balloon according to claim 1 including a closure member attached to the open end.

5. The balloon according to claim 4 where the closure member is manually operable or automatically operable in response to a predetermined gas pressure.

6. The balloon according to claim 1 where the weight of the two-way conductive wire is less than an inflated balloon.

7. The balloon according to claim 1 where said balloon has an internal reflective surface.

8. A balloon kit, including the following disassemble parts
a light weight, portable tank of helium gas;
a light weight, inflatable member having a transparent or translucent section and providing a cavity with an open end through which gas from the tank is injected to fill the cavity and inflate the member, said open end configured to be closed after being filled with the gas;
a light weight light source adapted to be positioned within the member to illuminates the member from inside the cavity, with light from said light source passing through said transparent or translucent section;
a ground based, portable control unit having a battery compartment to hold a battery and an on-off switch; and
a light weight, two-way conductive wire having one end adapted to be connected to the light source and another end adapted to be connected to a battery in the compartment to supply power to the light source under the control of the on-off switch.

9. A balloon inflating device, including
a body member having an inlet and outlet,
a passageway between the inlet and outlet to enable gas to flow from the inlet to the outlet,
said body member holding a light weight light source,
a light weight power source adapted to be connected to the light source,
a balloon clamp adapted to hold a balloon at the outlet to enable the balloon to be inflated with a gas that flows from the inlet though said passageway and out the outlet,
a valve that has an open position enabling gas to flow into a balloon attached to the body member at the outlet and a closed position that terminates gas flows, and
a control switch connected in a circuit including the light source and the power source.

10. The balloon inflating device according to claim 9 where said control switch actuated to apply power to the light source when the valve is in the closed position.

11. The combination of a balloon and the balloon inflating device of claim 9.

12. The combination according to claim 11 where
the body member includes a tubular element with a hollow interior having opposed open ends connected by a tubular wall having at least one orifice therein,
said light source being at one end and at the other end a plug member serving as a the valve,
said plug member extending within the hollow interior and being manually moveable between a first position unblocking the orifice and a second position blocking the orifice after the balloon is filled with gas.

13. The combination according to claim 12 where the tubular wall has a circular-cross section and the plug member has a circular-cross section and fits snugly within the tubular wall, said plug member having a distal end within the hollow interior and a proximal end extending from the interior, said distal end having an O-ring attached thereto.

14. The combination according to claim 13 where the body member has an exterior surface and the balloon clamp is on said exterior surface between the orifice and the end of the hollow interior from which said proximal end of the plug extends.

15. The combination according to claim 11 where the total weight of the combination is less than the balloon when inflated.

16. The combination according to claim 11 where the balloon is a light weight, inflatable member having a transparent or translucent section and a cavity with an open end through which gas enters to fill the cavity and inflate the member, said balloon inflating device extending into the open end of the inflatable member, so that gas flowing through said orifice inflates said inflatable member.

17. The combination according to claim 16 where the light source is positioned within the inflatable member to illuminate the member from inside the cavity, with light from said light source passing through said transparent or translucent section.

18. The combination according to claim 11 where said balloon has an internal reflective surface.

19. A method of advertising a subject by displaying indicia of the subject on a balloon and illuminating said balloon from inside of the balloon with the balloon aloft, and at least a section of the balloon being transparent or translucent to enable light to illuminate the indicia of the subject and draw spectator attention to the illuminated balloon.

20. The method of advertising according to claim 19 where the indicia of the subject is an image, name, symbol, trademark, or other signs identifying the subject.

21. The method of advertising according to claim 19 where the illumination of the balloon displays the indicia of the subject.

22. The method of advertising according to claim 19 where, at a gathering of spectators at an event promoted for, or by, the subject, at least one spectator send the balloon aloft by inflating and releasing it.

23. The method of advertising of claim 19 where said balloon is tethered with a light weight, two-way conductive wire to a ground based, portable control unit having a battery, said two-way conductive wire having one end connected to a light source within the balloon and another end connected to the battery.

24. The method of advertising according to claim 23 where the control unit includes an on-off switch which controls the supply power to the light source.

25. The method of advertising according to claim 19 where the balloon is inflated with a balloon inflating device, including
a body member having an inlet and outlet,
a passageway between the inlet and outlet to enable gas to flow from the inlet to the outlet,
said body member holding a light weight light source,
a light weight power source adapted to be connected to the light source,
a balloon clamp adapted to hold a balloon at the outlet to enable the balloon to be inflated with a gas that flows from the inlet though said passageway and out the outlet,
a valve that has an open position enabling gas to flow into a balloon attached to the body member at the outlet and a closed position that terminates gas flows, and
a control switch connected in a circuit including the light source and the power source.

26. The method of advertising according to claim 23 balloon inflating device according to claim 8 where said control switch actuated to apply power to the light source when the valve is in the closed position.

27. The method of advertising according to claim 19 including a source of music adapted to play music.

28. The method of advertising of claim 27 where the source of music plays music identified with the subject.

29. A method of enhancing festive occasions comprising inflating an releasing into the atmosphere at least one internally illuminated balloon having indicia thereon appropriate to the occasion.

30. A balloon device comprising a balloon having a therein a source of light that is energized to illuminate the balloon from within while aloft.
